(19) United States
(12) Patent Application Publication
(10) Pub. No.: US 2026/0064556 A1
(43) Pub. Date: Mar. 5, 2026

(54) PREDICTION COMPONENT VISUALIZATION SYSTEM

(71) Applicant: SAP SE, Walldorf (DE)

(72) Inventors: Nicolas DULIAN, Houilles (FR); David SERRE, Nice (FR)

(21) Appl. No.: 18/817,664

(22) Filed: Aug. 28, 2024

(51) Int. Cl. G06F 11/34; G06F 11/32

(52) U.S. Cl. CPC G06F 11/3419; G06F 11/32

(57) ABSTRACT

A system and method include reception of a request for a predicted value of a target over a time period, determination of first time-series data associated with the target, determination of a plurality of time-series components of the first data, determination of the predicted value of the target over the time period based on the plurality of time-series components, generation of a visualization including the predicted value and a contribution of each of the time-series components to the predicted value, and transmission of the visualization to a remote device.

### BACKGROUND

Time-series data includes values of a given parameter at successive and periodic time points (e.g., hourly, daily, weekly, monthly, annually, etc.). Examples of time-series data include monthly sales, daily stock prices, and annual profits. Processes may be employed to predict a future value of time-series data (i.e., the value of a given parameter at a future time point) based on observed past values of time-series data. The predicted value may be presented to a user within a visualization.

Preferably, a visualization of a predicted value can be efficiently interpreted by a user. Some systems attempt to enhance this understanding by providing, along with a visualization of the predicted value, global characterizations of the algorithm which generated the predicted value. These global characterizations indicate the impacts of trends, cycles, and/or other predictive factors on the overall output of the algorithm. Despite these efforts, the logic underlying a predicted value typically remains obscure and difficult for users to understand.

Systems to efficiently enhance understanding of a particular predicted value are desired. Such systems may promote user trust in the predicted value and in the underlying predictive algorithm.

### BRIEF DESCRIPTION OF THE DRAWINGS

Features and advantages of some embodiments, and the manner in which the same are accomplished, will become more readily apparent with reference to the following detailed description taken in conjunction with the accompanying drawings.

FIG. 1 is a view of a user interface presenting a visualization of a predicted value and of contributions of each of a plurality of time-series components to the predicted value according to some embodiments.

FIG. 2 is a flow diagram of a process to determine and present a visualization of a predicted value and of contributions of each of a plurality of time-series components to the predicted value according to some embodiments.

FIG. 3 is a block diagram of a data analytics system according to some embodiments.

FIG. 4 is a graph of time-series data.

FIG. 5 is a graph of time-series data and of a component of the time-series data according to some embodiments.

FIG. 6 is a graph of a difference between time-series data and a component of the time-series data according to some embodiments.

FIG. 7 is a graph of a cyclic component of time-series data according to some embodiments.

FIG. 8 is a graph of a residual of time-series data according to some embodiments.

FIG. 9 is a graph of time-series data and a plurality of components of the time-series data according to some embodiments.

FIG. 10 is a view of a user interface presenting a visualization of a predicted value and of contributions of each of a plurality of time-series components to the predicted value according to some embodiments.

FIG. 11 is a view of a user interface presenting a visualization of a predicted value and of contributions of each of a plurality of time-series components to the predicted value, and a visualization of a time-series of predicted values according to some embodiments.

FIG. 12 is a view of a user interface presenting a visualization of a predicted value and of contributions of each of a plurality of time-series components to the predicted value, and a visualization of global contributions of each of the plurality of time-series components according to some embodiments.

FIG. 13 is a view of a user interface presenting a visualization of a predicted value and of contributions of each of a plurality of time-series components to the predicted value, and a visualization of contributions of values of a cyclic component to the predicted value according to some embodiments.

FIG. 14 is a block diagram of a data analytics system according to some embodiments.

FIG. 15 is a block diagram of a cloud-based implementation according to some embodiments.

### DETAILED DESCRIPTION

In the following description, specific details are set forth in order to provide a thorough understanding of various embodiments. Various modifications to the embodiments will be readily apparent to those skilled in the art, and the one or more principles defined herein may be applied to other embodiments and applications without departing from the spirit and scope of the present disclosure. Moreover, in the following description, numerous details are set forth for the purpose of explanation. One of ordinary skill in the art should understand that embodiments may be practiced without the use of these specific details. In other instances, well-known structures, methods, procedures, components, and circuits are not shown or described so as not to obscure the description with unnecessary detail. Thus, the present disclosure is not intended to be limited to the embodiments shown but is to be accorded the widest scope consistent with the principles and features disclosed herein.

The present disclosure relates to visualization of a predicted value. A visualization of a predicted value according to some embodiments includes the predicted value and a contribution for each of a plurality of time-series components of the predicted value. The visualized contribution for each of the plurality of time-series components of the predicted value represents a contribution of a component to the predicted value. In some embodiments, the contribution is a positive or negative contribution to the value. The contribution of a time-series component may be presented in the units of the predicted value, as a percentage of the predicted value, and/or in any other manner.

In one example, a request is received to predict a value of a particular target (e.g., Sales in Europe) for a future time point or period. A time-series of values of the target is determined based on historical data and the predicted value is determined based on the time-series of historical values of the target. Determination of the predicted value may include decomposition of the time-series of historical values of the target into time-series components. A contribution of each time-series component is determined for the future time point or period, and the values are summed to determine the predicted value. Contrary to conventional systems which may determine trend, cycle and fluctuation time-series components from a time-series of target values, embodiments are capable of determining an influencer component which may contribute to the trend component and/or the cycle component determined by prior systems. A visualization may then be generated including the predicted value and the contributions of any identified trend, cycle, influencer and fluctuation components.

According to some embodiments, a visualization may present the contributions of the components in a manner which illustrates the extent and direction of their impacts on the predicted value, such as via a waterfall chart. Such a chart may depict the collective influence of successive positive and negative contributions on a predicted value. The positive and negative contributions may be ordered from largest to smallest absolute value, by type of associated component, alphabetically by component name, and/or by any other ordering characteristic.

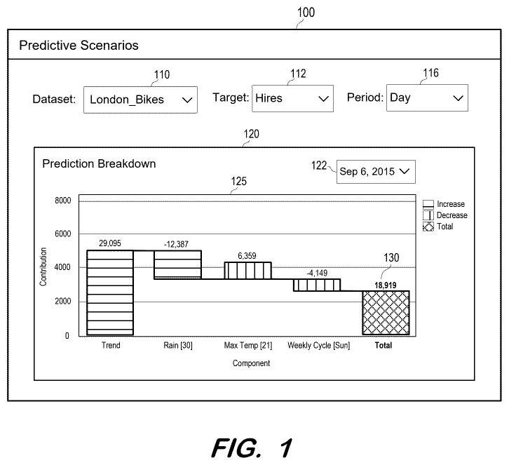

FIG. 1 is a view of user interface 100 presenting a visualization of a predicted value and of contributions of each of a plurality of time-series components to the predicted value according to some embodiments. User interface 100 may be presented on a display in response to execution of program code by one or more processing units. Embodiments are not limited to the contents of user interface 100.

User interface 100 includes drop-down menu 110 for selecting a dataset from which to predict a value. A dataset may comprise a relational database table, a view on one or more views and/or relational database tables, an object, or any other data structure. Drop-down menu 112 allows selection of a particular target (i.e., measure/column/field) of the selected dataset for which a value is to be predicted. Drop-down menu 116 allows a user to select a granularity of aggregation of the target (e.g., day, month, quarter, year). Drop-down menu 122 of area 120 allows selection of a particular time period for which to predict the target value, with the selectable time periods having the duration selected in drop-down menu 116.

Area 120 of user interface 100 also includes visualization 125. Visualization 125 is a waterfall chart but embodiments are not limited thereto. Visualization 125 includes predicted value 130 of the selected target for the selected time period, and contributions of time-series components of the predicted value to the predicted value. The contributions of time-series components of the predicted value may be generated during determination of the predicted value as will be described below. Visualization 125 may be considered the local explanation of a predicted value, where the local state is defined by the selected date and values of the components for the selected date (i.e., 30, 21, Sun, respectively).

The time-series components of visualization 125 are Trend, Rain, Maximum Temp, and Weekly Cycle. According to some embodiments, components may be of type Trend, Cycle, Influencers and Fluctuation. Time-series components of a particular target may include more than one Cycle-type component (e.g., Seasonal Cycle, Monthly Cycle) and/or more than one Influencer-type component (e.g., Rain, Advertising budget, Temperature). The units of value 130 are number of rides per day, and the units of the illustrated contributions are also number of rides per day.

According to the example of FIG. 1, the dataset London_Bikes includes the number of public bike hires in London from January 2015 to August 2015. The user desires a prediction of the number of bike hires which will occur on Sep. 6, 2015.

Determination of the predicted value may include determining a historical time-series of the number of public bike hires in London from January 2015 to August 2015. A Trend time-series component of the historical time-series is then determined. Since the number of public bike hires is stable from Monday to Friday and much lower during the weekend, a weekly Cycle-Type time-series component is also determined.

The desirability of public bike hires is affected by the weather. Two Influencers are therefore identified, specifically the predicted amount of rain and the predicted maximum temperature for a given day. As noted above, these Influencers may impact both the Trend time-series component and any Cycle-type time-series components. Therefore, according to some embodiments, the previously-determined Trend time-series component is decomposed into a time-based Trend component and, for each Influencer, an influencer-based Trend component. In the present example, an influencer-based Trend component might not exist for one or both of the “rain” and “maximum temperature” influencers.

Similarly, the determined Cycle-type component may be decomposed into a time-based Trend component and, for each Influencer, an influencer-based Cycle-type component. Again, an influencer-based Cycle-type component might not exist for one or both of the “rain” and “maximum temperature” influencers.

In other notation, a conventional system may determine a forecast as Forecast=Trend+Cycle+Fluctuation. Decomposing Trend and Cycle to include impacts cause by the potential influencers Rain and Max Temp gives Forecast(N)=Trend(time)+Trend(Rain)+Trend(MaxTemp)+Cycle(time)+Cycle(Rain)+Cycle(MaxTemp)+Fluctuation(N). Assuming Rain=Trend(Rain)+Cycle(Rain) and MaxTemp=Trend(MaxTemp)+Cycle(MaxTemp), Forecast=Trend(time)+Cycle(time)+Fluctuation(N)+Rain+MaxTemp.

The predicted value for a given date may be equal to the sum of the contributions of the determined time-series components (i.e., Trend(time)+Cycle(time)+Fluctuation(N)+Rain+MaxTemp) on that date. Visualization 125 shows the predicted value of bike hires for Sep. 6, 2015 as 18,919 bike hires. Based solely on the Trend time-series trend, one would predict 29,095 hires. However, because a fair amount of rain is expected during that day (30 mm), the predicted value is decreased by 12,387 hires. The rather mild (21° C.) temperature causes an increase in the prediction of 6,359 and, because Sep. 6, 2015 is a Sunday, the Weekly Cycle time-series component decreases the predicted value by 4,149.

Selection of a different time period in drop-down menu 122 results in generation of a different predicted value and different time-series component-specific contributions. Accordingly, selection of a different time period in drop-down menu 122 results in a different visualization.

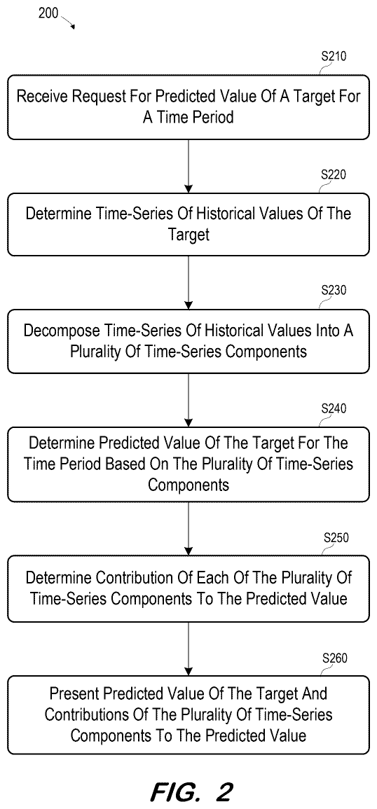

FIG. 2 is a flow diagram of process 200 to determine and present a visualization of a predicted value and of contributions of each of a plurality of time-series components to the predicted value according to some embodiments. Process 200 and the other processes described herein may be performed using any suitable combination of hardware and software. Program code embodying these processes may be stored by any one or more non-transitory tangible media, including a fixed disk, a volatile or non-volatile random-access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described herein.

Initially, a request for a predicted value of a target is received at S210. The request specifies a time period for which the predicted value is to be calculated. The request may be received via a user interface presented by an application executing on a user device.

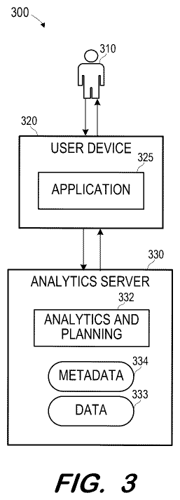

FIG. 3 is a block diagram of data analytics system 300 for executing process 200 according to some embodiments. Each of the illustrated components may be implemented using any suitable combination of on-premise, cloud-based, distributed (e.g., including distributed storage and/or compute nodes) computing hardware and/or software that is or becomes known. Each computing system described herein may comprise one or more physical and/or virtualized servers.

Two or more components of FIG. 3 may be co-located. In some embodiments, two or more components are implemented by a single computing device. One or more components may be implemented as a cloud service (e.g., Software-as-a-Service, Platform-as-a-Service). A cloud-based implementation of any components of FIG. 3 may apportion computing resources elastically according to demand, need, price, and/or any other metric.

According to some embodiments, user 310 may interact with user device 320 to generate the request at S210. User device 320 may comprise a desktop computer, a laptop computer, a smartphone, a tablet, etc. User device 320 executes application 325 to present a user interface such as user interface 100 to user 310. Application 325 may comprise a Web browser which requests Web pages from a remote Web server and presents the Web pages to user 310. Application 325 may comprise a front-end UI application executing within a Web browser which also executes within user device 320.

Analytics server 330 may comprise one or more servers, virtual machines, clusters of a container orchestration system, etc. Analytics server 330 may provide an operating system, services, I/O, storage, libraries, frameworks, etc. to applications executing therein. Analytics and planning application 332 may comprise program code executable by a processing unit of analytics server 330 to provide functions based on coded logic and on data 333. Data 333 may comprise tabular data stored in a columnar or row-based format, object data or any other type of data that is or becomes known. Metadata 334 describes the structure and relationships of data 333 as is known in the art, including but not limited to table schemas. Data 333 and metadata 334 may be stored by any suitable storage system such as database system, which may be partially or fully remote analytics server 330, and may be distributed as is known in the art.

Application 325 may communicate with analytics and planning application 332 in response to requests received from user 310. For example, user 310 may operate application 325 to specify a dataset, a target, and a time period, and to request generation of a predicted value of the target for the time period based on the dataset. Application 325 may then transmit the request to analytics and planning application 332, where the request is received at S210.

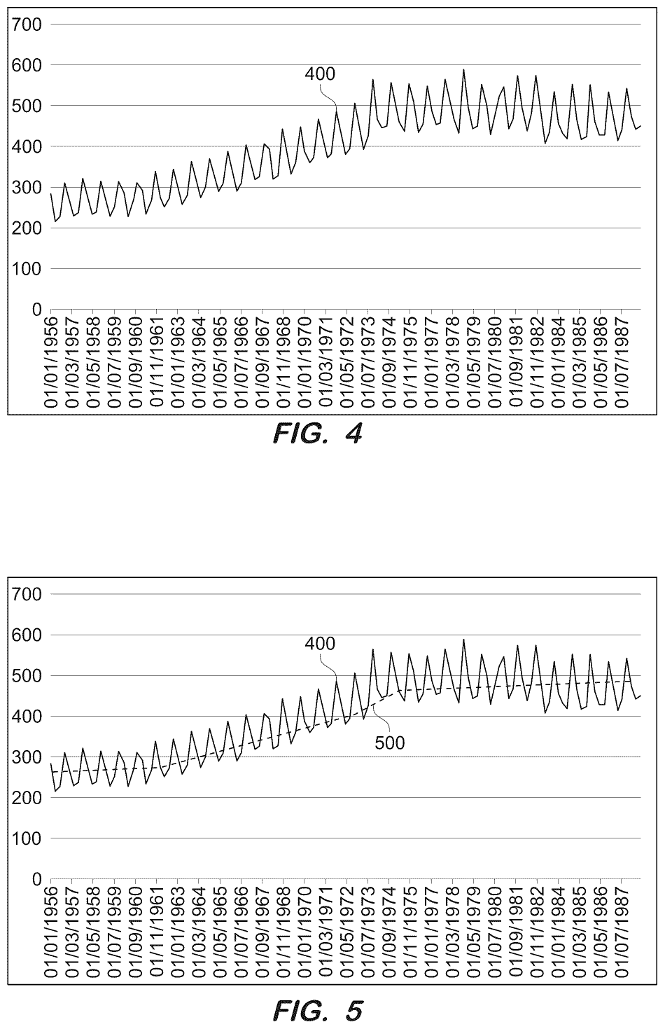

A time-series of historical values of the target is determined at S220. FIG. 4 is a graph of time-series 400 for describing an example of process 200. Time-series 400 may be determined from data 333 or received from an external component. Time-series 400 includes values for dates which precede the time period specified in the request received at S210.

Next, at S230, the time-series of historical values is decomposed into a plurality of time-series components. According to some embodiments, a system might use several modeling techniques (e.g., single/double/triple exponential smoothing, piecewise linear decomposition, linear regression, distributed lag) to generate several predictions for various components of a time-series. For each time-series component, the system may compare the predictions generated using different modeling techniques and determine the “best” prediction based on one or more prediction quality objectives.

According to one non-exhaustive example, S230 includes determining a Trend component of the time-series of historical values. As mentioned above, several modeling techniques (e.g., signal decomposition models, smoothing models) may be applied to the time-series of historical values to determine a candidate Trend components of the time-series of historical values and the results compared to determine a final Trend component. FIG. 5 is a graph of time-series 400 and of Trend component 500 of time-series 400 according to some embodiments. Trend component 500 includes three linear segments but embodiments are not limited thereto.

As described above, Trend component 500 may be decomposed into a time-based Trend time-series component and a time-series component for each of one or more Influencers. The time-based Trend time-series component and any identified Influencer-specific time-series components of the Trend component are saved to assist in future determinations as described below.

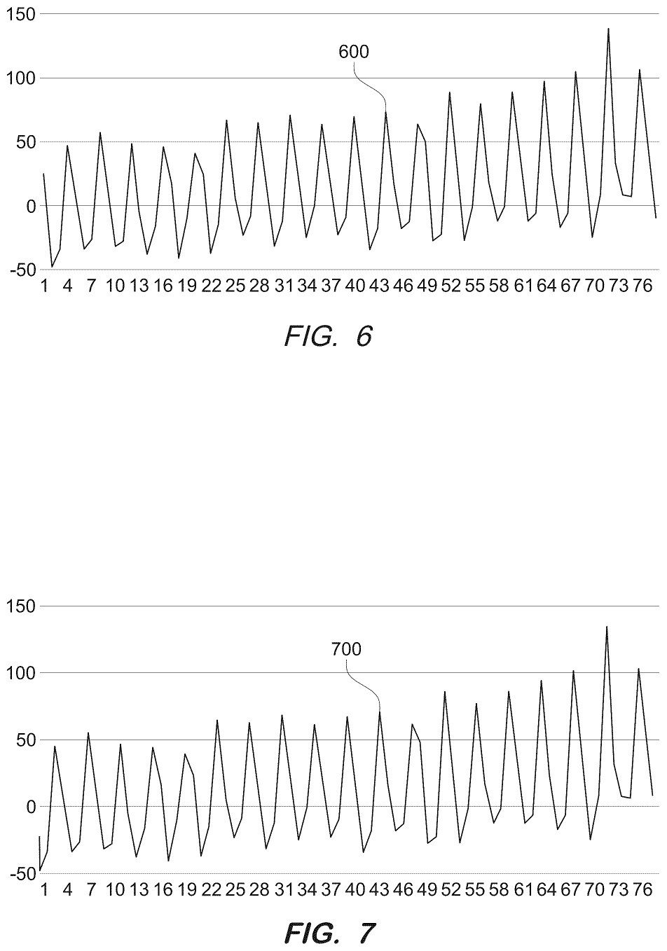

According to some signal decomposition models, the time-series of historical values is then “de-trended” by subtracting the identified Trend component. FIG. 6 is a graph of residue 600 between time-series 400 and Trend component 500 of FIG. 5 according to some embodiments. The Trend component which is subtracted from the time-series of historical values includes the time-based Trend time-series component and any influencer-specific time-series component which may have been identified. S230 may then proceed to determine whether the residue represents one or more Cycle components.

For example, the residue may be evaluated with respect to calendar cycles such as monthOfYear, dayOfMonth, and fixed period. In the present example, Cycle component 700 of FIG. 7 is based on quarterOfYear and appears to match residue 600. Cycle component 700 is multiplicative, in that the value for the first quarter of year N is lesser than the value of the first quarter of year N+1. Cycle component 700 may then be decomposed into a time-based Cycle time-series component and a time-series component for each of one or more Influencers.

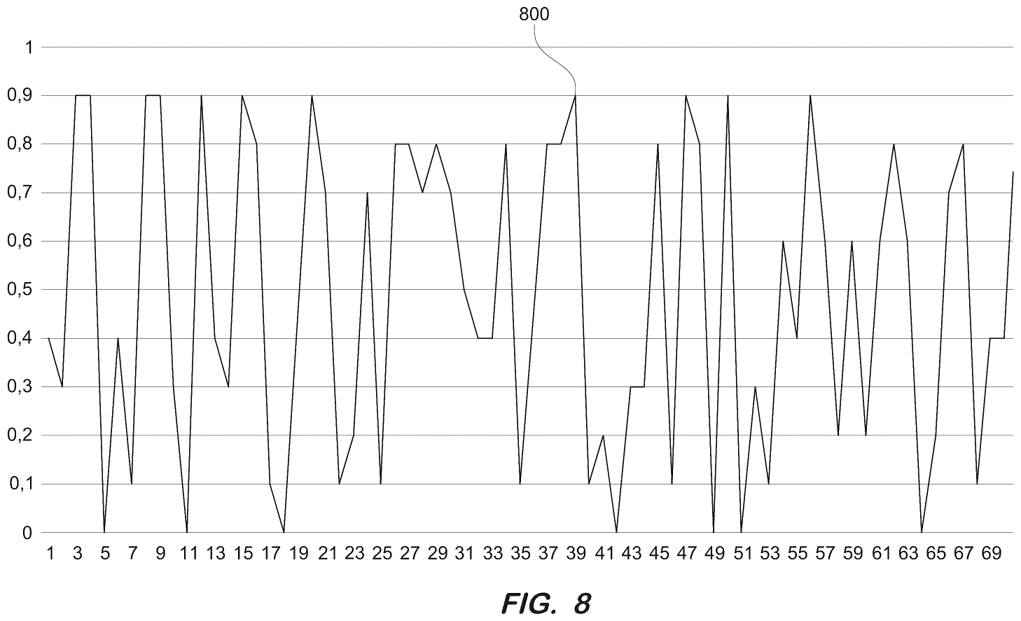

Trend component 500 and Cycle component 700 are subtracted from time-series 400 to generate residue 800 of FIG. 8. At this point of S230, an attempt is made to identify a Fluctuation component which corresponds to residue 800. It is assumed that no suitable Fluctuation component is determined.

Accordingly, the time-series components determined at S230 comprise the time-based Trend time-series component of Trend component 500 and the time-based time-series component of Cycle component 700. Assuming that Trend component 500 and Cycle component 700 each include a time-series component specific to a first influencer and a time-series component specific to a second influencer, the time-series components determined at S230 also comprise a first Influencer component and a second Influencer component. The first Influencer component is the sum of the time-series component of Trend component 500 which is specific to the first influencer and the time-series component of Cycle component 700 which is specific to the first influencer, and the second Influencer component is the sum of the time-series component of Trend component 500 which is specific to the second influencer and the time-series component of Cycle component 700 which is specific to the second influencer.

The predicted value of the target for the time period is determined at S240 based on the plurality of time-series components determined at S230. According to some embodiments, the values of each component for the time period are summed to determine the predicted value of the target for the time period.

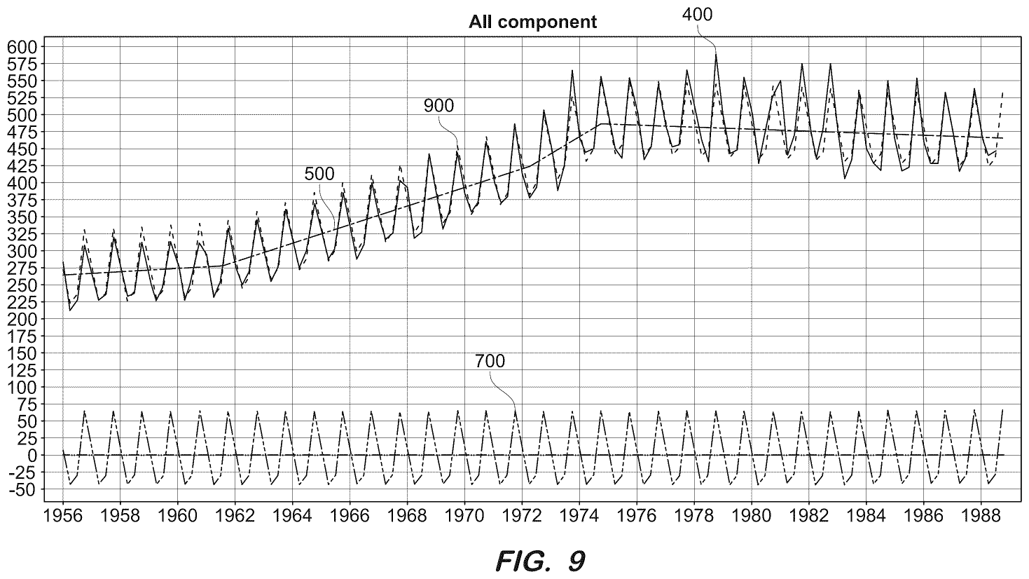

FIG. 9 shows time-series 900 representing a prediction signal. Time-series 400 of historical values is also displayed for clarity. The prediction signal is equal to the sum of Trend component 500 and Cycle component 700. Due to the decompositions described above, the prediction signal is also equal to the sum of the time-based Trend time-series component of Trend component 500, the time-based time-series component of Cycle component 700, the first Influencer component and the second Influencer component.

Next, at S250, a contribution of each of the plurality of time-series components to the predicted value is determined. The predicted value of the target and the contributions determined at S250 are presented at S260. S260 may comprise generation of a Web page including a visualization such as visualization 125 and transmitting the Web page to a user device. The Web page may conform to a Web UI framework and may be interpreted and presented by a corresponding application executing on the user device. Embodiments are not limited to visualization 125.

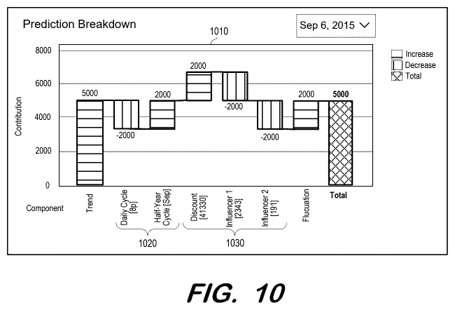

FIG. 10 depicts visualization 1010 according to some embodiments. Visualization 125 described above displays each contribution in descending order of magnitude. In case some components have the exact same contribution, these contributions may be ordered by component type as shown in visualization 1010. Such a visualization may enhance comprehension in some scenarios and/or for some users. From left-to-right, the equal-valued contributions of visualization 1010 are ordered by Cycle components, Influencer components and Fluctuation component.

Since the contributions of the Cycle components and the Influencer components are equal, the additional ordering criteria of alphabetical ordering is used in the present example. As shown, Cycle components 1020 are ordered alphabetically and Influencer components 1030 are also ordered alphabetically.

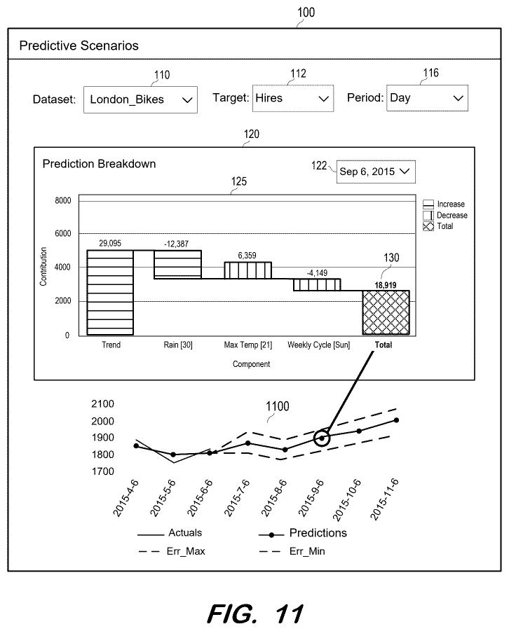

FIG. 11 shows interface 100 with additional visualization 1100. For the selected target, visualization 1100 shows actual (where available) and predicted values for each of a plurality of time periods. Visualization 1100 also shows minimum and maximum error curves associated with the predicted values. As illustrated in FIG. 11, the predicted value shown in visualization 1100 for the selected time period (September 6, 2015) is equal to the total value 130 of visualization 125.

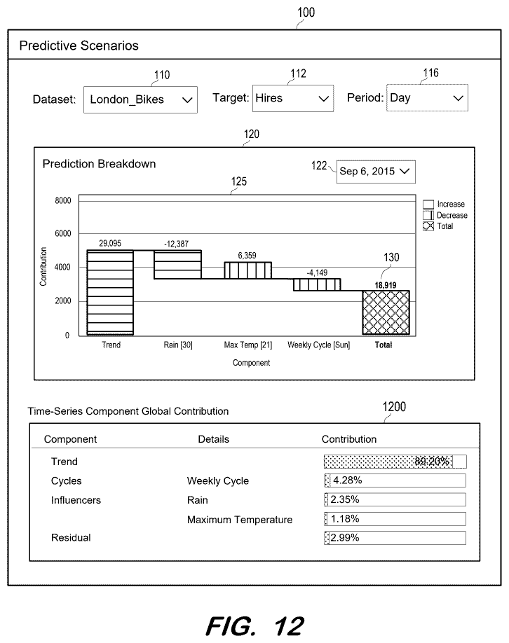

FIG. 12 shows interface 100 with additional visualization 1200. Visualization 1200 depicts the global contribution (in percentage terms) of each time-series component on the values predicted by the current predictive algorithm (i.e., predictive model). The global contribution of a time-series component is an aggregate value reflecting all predictions made by the algorithm, and does not necessarily equal the contribution of that component to a particular predicted value determined by the algorithm.

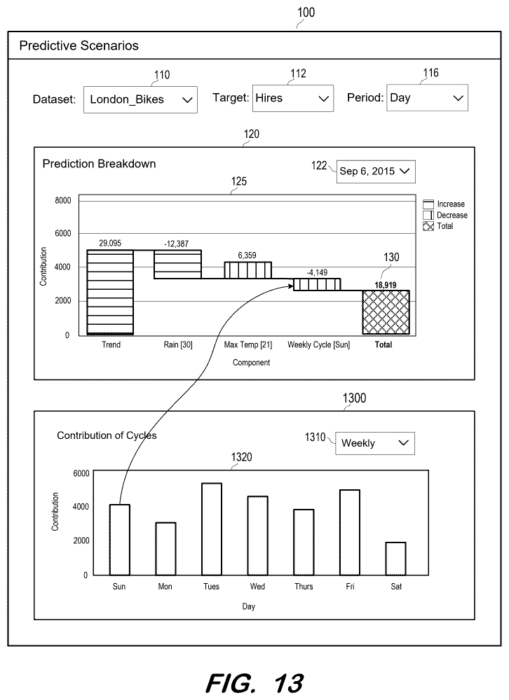

FIG. 13 shows interface 100 with additional panel 1300. Panel 1300 includes drop-down menu 1310 for selecting one of the Cycle components of the time-series of historical values. Visualization 1320 shows the contribution to the predicted value which is associated with each value of the Cycle. As shown in visualization 1320, the contribution of the value Sun is −4,149. This contribution is consistent with the contribution of the Weekly Cycle component shown in visualization 125, since the value of Weekly Cycle component for selected time period Sep. 6, 2015 is Sun.

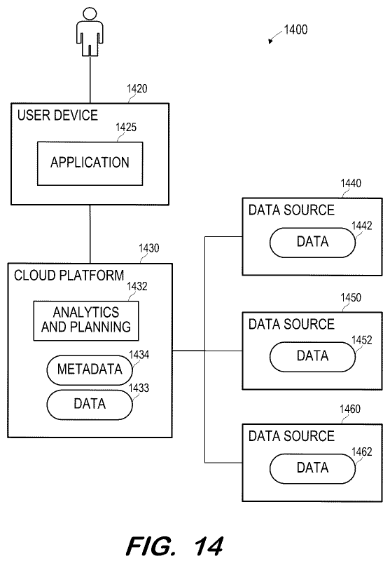

FIG. 14 is a block diagram of data analytics system 1400 according to some embodiments. User device 1420 and application 1425 may operate as described above with respect to user device 320 and application 325. Similarly, cloud platform 1430 may operate as described above with respect to analytics server 330 to execute analysis and planning application 1432 to determine and present predicted values based on data 1433.

Cloud platform 1430 may also communicate with data sources 1440, 1450 and 1460. Data sources 1440, 1450 and 1460 may comprise any on-premise and/or cloud-based systems that are or become known, including but not limited to data warehouses, object stores, and databases. According to some embodiments, cloud platform 1430 imports (via push and/or pull mechanisms) data from data 1442, 1452 and 1462 for storage in data 1433. The data may be imported according to source-specific schedules or in any other manner. The imported data may be transformed to a model described in metadata 1434 prior to storage in data 1433 to facilitate subsequent analysis thereof.

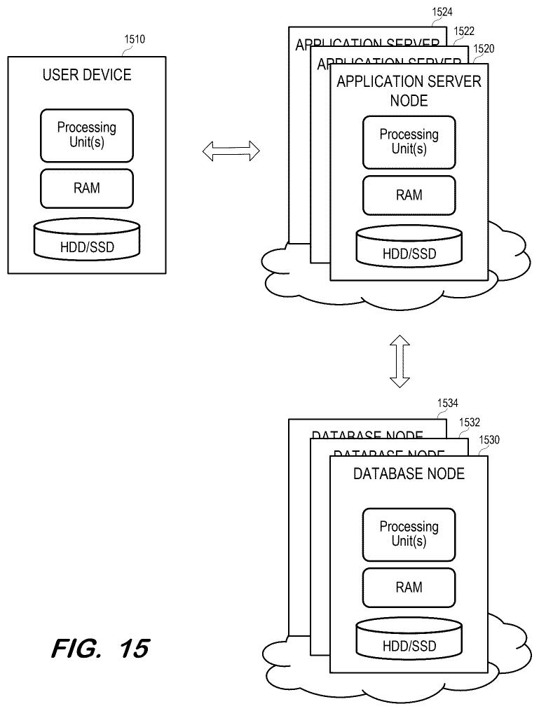

FIG. 15 is a block diagram of a cloud-based implementation according to some embodiments. User device 1510 may comprise any computing device that is or becomes known. Application server nodes 1520, 1522 and 1524 implement a container orchestration platform (e.g., Kubernetes) for execution of instances of an analysis and planning application as described therein. Database nodes 1530, 1532 and 1534 may also implement a container orchestration platform for execution of database instances for storing historical time-series data as described therein. Each node may comprise a virtual machine allocated by a cloud provider providing self-service and immediate provisioning, autoscaling, security, compliance and identity management features.

For example, an application instance executing on a node 1520, 1522 or 1524 receives a request for predicted values from user device 1510 and determines corresponding historical time-series data from a database instance of database node 1530, 1532 or 1534. The application instance determines a predicted value and contributions of time-series components to the predicted value, and a visualization including the predicted value and contributions. The visualization is transmitted to user device 1510 for presentation to a user (e.g., by means of a display).

As will be appreciated based on the foregoing specification, the above-described examples of the disclosure may be implemented using computer programming or engineering techniques including computer software, firmware, hardware or any combination or subset thereof. Any resulting computer program, consisting of computer-readable program code, may be embodied or provided within one or more non-transitory computer-readable media, thereby making a computer program product, i.e., an article of manufacture, according to the discussed examples of the disclosure. The non-transitory computer-readable media may be, but is not limited to, a fixed drive, diskette, optical disk, magnetic tape, flash memory, external drive, semiconductor memory such as read-only memory (ROM), random-access memory (RAM), and any other non-transitory transmitting or receiving medium such as the Internet, cloud storage, the Internet of Things (IoT), or other communication network or link. The article of manufacture containing the program code may be made and used by executing the program code directly from one medium, by copying the program code from one medium to another medium, or by transmitting the program code over a network.

The program code may include, for example, machine instructions for a processing unit, and may be implemented in a high-level procedural, object-oriented programming language, assembly/machine language, etc. As used herein, the terms “machine-readable medium” and “computer-readable medium” refer to any computer program product, apparatus, cloud storage, Internet of Things, and device (e.g., magnetic discs, optical disks, memory, programmable logic devices (PLDs)) used to provide instructions and data to a processing unit, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and any other kind of data to a processing unit.

The above descriptions and illustrations of processes herein should not be considered to imply a fixed order for performing the processes. Rather, the processes may be performed in any order that is practicable, including simultaneous performance of at least some steps. Although the disclosure has been described in connection with specific examples, it should be understood that various changes, substitutions, and alterations apparent to those in the art can be made to the disclosed embodiments without departing from the spirit and scope of the disclosure as set forth in the appended claims.

What is claimed is:

1. A method comprising:
determining first time-series data associated with a target;
determining a plurality of time-series components of the first data;
determining a predicted value of the target over a time period based on the plurality of time-series components; and
generating a visualization including the predicted value and a contribution of each of the time-series components to the predicted value.

2. The method of claim 1, wherein determining the predicted value of the target comprises:
determining the contribution of each of the plurality of time-series components to the predicted value; and
determining the predicted value based on the determined contributions.

3. The method of claim 2, wherein the contribution of a time-series component to the predicted value comprises a value of the time-series component over the time period.

4. The method of claim 1, wherein the plurality of time-series components comprise a trend time-series component, a cycle time-series component and an influencer time-series component.

5. The method of claim 1, wherein the visualization comprises a waterfall chart depicting the predicted value and the contribution of each of the time-series components to the predicted value.

6. The method of claim 1, wherein the visualization comprises a second predicted value of the target over a second time period.

7. The method of claim 1, wherein the visualization comprises a global contribution of each of the time-series components.

8. The method of claim 1, wherein the visualization comprises a contribution of each of a plurality of values of a time-series component.

9. A system comprising:
a memory storing executable program code; and
a processor to execute the executable program code to cause the system to:
determine first time-series values of a target;
determine a plurality of time-series components of the first time-series values;
determine a predicted value of the target over a time period based on the plurality of time-series components; and
generate a visualization including the predicted value and a contribution of each of the time-series components to the predicted value.

10. The system of claim 9, wherein determination of the predicted value of the target comprises:
determining the contribution of each of the plurality of time-series components to the predicted value; and
determining the predicted value based on the determined contributions.

11. The system of claim 10, wherein the contribution of a time-series component to the predicted value comprises a value of the time-series component over the time period.

12. The system of claim 9, wherein the plurality of time-series components comprise a trend time-series component, a cycle time-series component and an influencer time-series component.

13. The system of claim 9, wherein the visualization comprises a waterfall chart depicting the predicted value and the contribution of each of the time-series components to the predicted value.

14. The system of claim 9, wherein the visualization comprises a second predicted value of the target over a second time period.

15. The system of claim 9, wherein the visualization comprises a global contribution of each of the time-series components.

16. The system of claim 9, wherein the visualization comprises a contribution of each of a plurality of values of a time-series component.

17. One or more non-transitory computer-readable media storing program code, which when executed by at least one processing unit cause a computing system to perform a method comprising:
receiving a request for a predicted value of a target over a time period;
determining first time-series data associated with the target;
determining a plurality of time-series components of the first data;
determining the predicted value of the target over the time period based on the plurality of time-series components;
generating a visualization including the predicted value and a contribution of each of the time-series components to the predicted value; and
transmitting the visualization to a remote device.

18. The one or more non-transitory computer-readable media of claim 17, wherein determining the predicted value of the target comprises:
determining the contribution of each of the plurality of time-series components to the predicted value; and
determining the predicted value based on the determined contributions.

19. The one or more non-transitory computer-readable media of claim 17, wherein the visualization comprises a second predicted value of the target over a second time period.

20. The one or more non-transitory computer-readable media of claim 17, wherein the visualization comprises a contribution of each of a plurality of values of a time-series component.
